(19) United States
(12) Patent Application Publication
(10) Pub. No.: US 2011/0303342 A1
(43) Pub. Date: Dec. 15, 2011

(54) Tape Applicator

(76) Inventors: Dean Robert Sherriff, North Yorkshire (GB); David Terry Seymour, West Yorkshire (GB)

(21) Appl. No.: 13/119,302

(22) PCT Filed: Sep. 16, 2009
(86) PCT No.: PCT/GB2009/002206

§ 371 Date: Apr. 8, 2011

(30) Foreign Application Priority Data
Sep. 17, 2008 (GB) 0817019.3

(51) Int. Cl. B32B 37/02; B32B 37/14

(52) U.S. Cl. 156/60; 156/349

(57) ABSTRACT

The invention relates to an applicator device (2) and a method of application which allows one or more adhesive tapes to be applied to a surface, with the tape or tapes being applied at a known offset distance (x) from at least one datum. This ensures that the tape can be applied at the required location to allow further work, such as the application of a sealant to be achieved accurately and neatly in a gap formed between the lengths of tapes. In one embodiment the device (2) has at least one, but typically both side wall portions (14,16) which can be adjusted with regard to the body (4) of the device to allow the offset distance (x) of the tape from a datum to be selectable.

The inventions which is the subject of this application is an applicator device which allows a length of tape, and in particular adhesive tapes, to be applied in a controlled manner such that the tape can be applied in a defined location, and furthermore can be applied in a uniform manner along the length of applied tape. In particular, although not necessarily exclusively, the invention relates to the ability to apply at least one length of tape in a position which is offset by a selected distance from a datum.

The use of adhesive tapes is widespread and one common use is for the tape to be applied to protect a surface, such as a wall or floor, adjacent to which a further material is to be applied. The further material may for example be sealant or paint and the aim is to apply the said further material onto the surface adjacent to the tape but not on the surface to which the tape has been applied. In order for this to be done successfully there is a need for the tape to be applied accurately so as to leave the exposed surface available for the application of the material and also to ensure that the adjacent surface is protected. This can be difficult to achieve when applying the tape manually and can be made even more difficult when the surface to which the tape is to be applied is relatively uneven and/or inaccessible such as the corner between two walls.

It is known to provide special forms of tapes for specific purposes such as providing twin lengths of tape which can be applied to either side of a corner of a wall or tiling and, once applied, a gap is left or formed between the lengths of tape at the corner to allow further material, in this case a sealant, to be applied along the gap. In practice it is found that the application of the tape lengths is difficult to achieve accurately and the tape itself can be prohibitively expensive to manufacture and/or buy which has led to its commercial use being restricted.

The aim of the present invention is to provide means for the application of tape which allows the tape to be applied in an efficient and accurate manner and without the need for relatively complex tape designs to be used.

In a first aspect of the invention there is provided a tape applicator device, said device including a supply of the tape to be dispensed, and at least one side wall portion which lies to a side of the longitudinal edges of the tape and wherein at least part of the external surface of said at least one side wall portion of the applicator device can be selectively positioned at a distance from the adjacent longitudinal edge of the tape.

In one embodiment the said distance is adjustable by a user selectively moving the side wall portion with respect to the tape and more specifically to provide relative movement with respect to the body of the device on which the tape is mounted.

Typically the selection is between a range of known predetermined distances. In one embodiment the device is provided with a mechanism to allow the user selected distance position to be locked by releasable locking means thereby maintaining the offset distance during use of the applicator.

In one embodiment side wall portions on opposing sides of the tape are both movable so as to allow the distance between the external surfaces of the same and the respective adjacent longitudinal edge of the tape held on the body of the device to be adjusted. Typically the location of the tape on the body is retained accurately so as to ensure that the offset distance selected is accurate and maintained during application of the tape.

In one embodiment the movement of one of the side wall portions causes the automatic movement of the other of the side wall portions with respect to the body of the device and typically to the same extent in an opposing direction.

Typically the side wall portions are provided with inwardly extending means which contact within the applicator device and/or each other such that rotation of one causes rotation of the other portion. Typically each of the portions are threaded with opposing threads and are received in a threaded part of the body of the applicator.

Typically the body portion supports the tape supply. Typically the tape supply is provided in a roll, the core of which is received and retained by the body portion of the applicator.

Typically the free end of the tape is passed to an applicator nib, of the device, said nib located such that the tape end can be applied to the surface and the movement of the applicator nib along the surface causes the tape to be drawn from the roll along the surface.

In one embodiment the tape is a foil with an adhesive surface which allows the tape to be applied in position.

In a further aspect there is provided a tape applicator device wherein the device includes a first side wall portion to be placed and offset with respect to a first datum to allow a first length of tape to be applied along a surface and a second side wall portion to be placed and offset with respect to the first of a further datum to allow a second length of tape to be applied.

In one embodiment the first and second lengths of tape are spaced apart along adjacent longitudinal edges.

In accordance with the invention there is provided an offset tape applicator which allows the accurate application of a length of tape offset a distance from a known datum. In one embodiment there is provided an applicator which allows the application of a length of tape in which either of the longitudinal edges of the tape can be applied by a predetermined offset distance from a datum.

In a further aspect of the invention there is provided a method of applying a tape to a surface, said method comprising placing a tape supply in an applicator, applying the free end of the tape onto the surface and adhering the tape to the surface by moving the device with respect to the surface to draw the tape from the device and wherein at least one of the longitudinal edges of the tape is located so as to be offset a known distance from a datum line or surface by selective adjustment of at least part of a side wall portion of the device and which side wall portion is positioned to contact with and/or be moved along the datum line or surface.

Typically the said side wall portion is releasably locked in position at any of a predetermined range of distances from the longitudinal edge of the tape.

Typically first and second side wall portions are positioned with respect to the longitudinal edges of the tape and are adjustable to allow the offset distance between each side wall portion external face and the adjacent longitudinal edge of the tape to be adjusted.

In one embodiment the applicator device is used to apply tape to either or both sides of an angled interface between two planar surfaces to leave an exposed area along the interface. In this case, when the first tape is applied to a first surface the second surface acts as the datum by being contacted by the external face of one of the side wall portions as the tape is applied, and the second tape is subsequently applied to the second surface with the first surface acting as the datum by being contacted by the external face of the other of the side wall portions as the tape is applied. This therefore means that each of the tapes is offset from the interface by a known distance, on either side of the interface to form a gap for the reception, typically of a sealant or other substance. Typically the said known offset distance is the same for both tapes.

A specific embodiment of the invention is now described with reference to the accompanying drawings; wherein

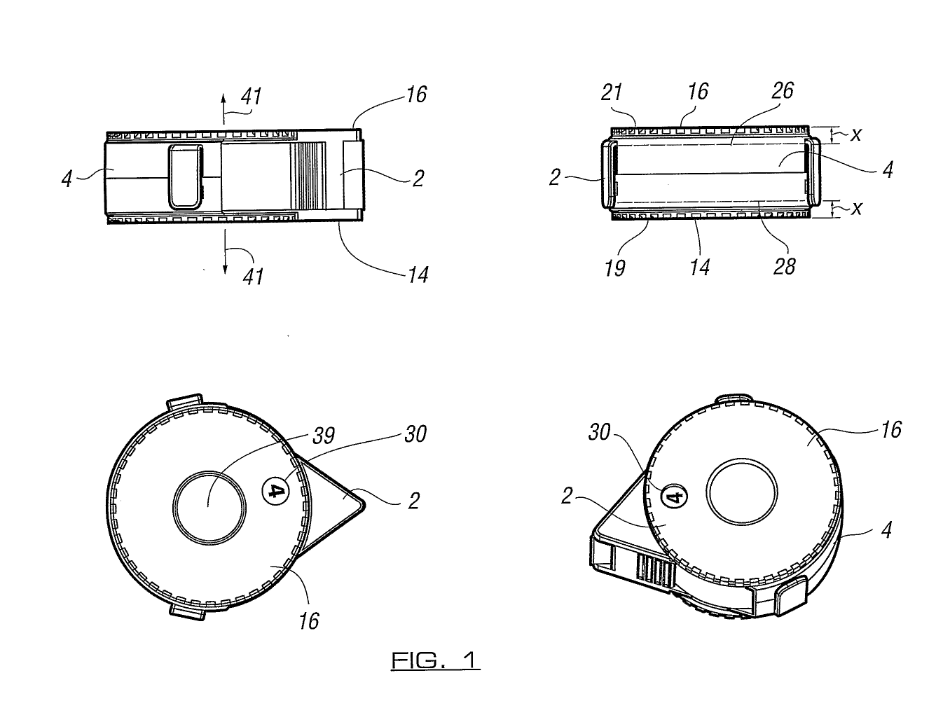

FIG. 1 illustrates a device in accordance with one embodiment of the invention in a first position;

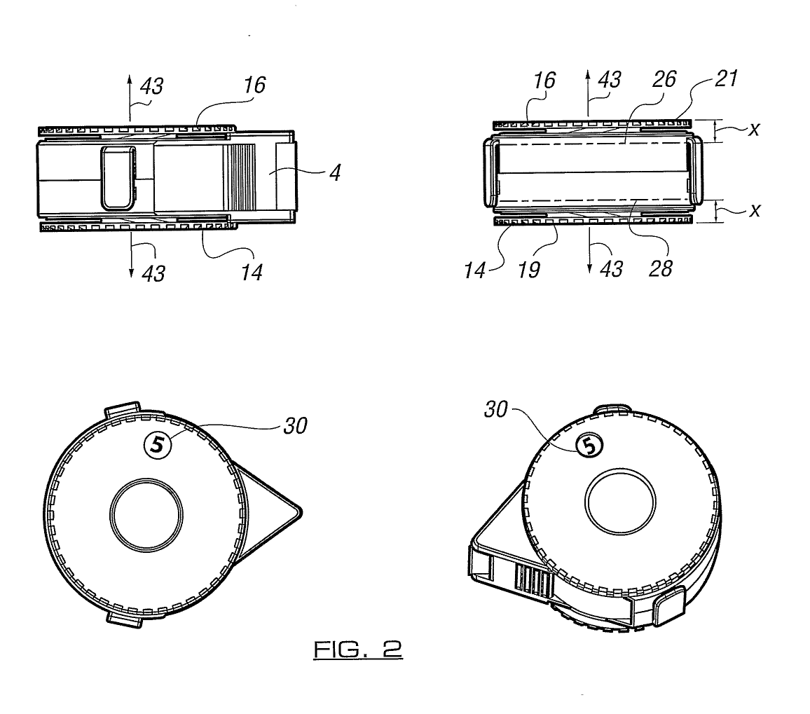

FIG. 2 illustrates a device in accordance with one embodiment of the invention in a second position;

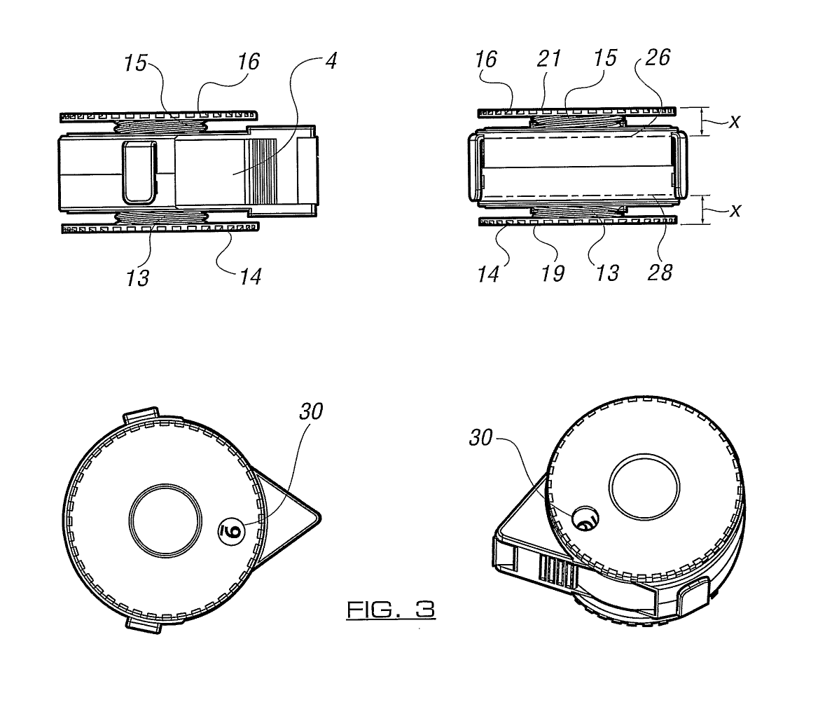

FIG. 3 illustrates the device of FIGS. 1 and 2 in a third position;

FIG. 4 illustrates an exploded view of the device of FIGS. 1-3,

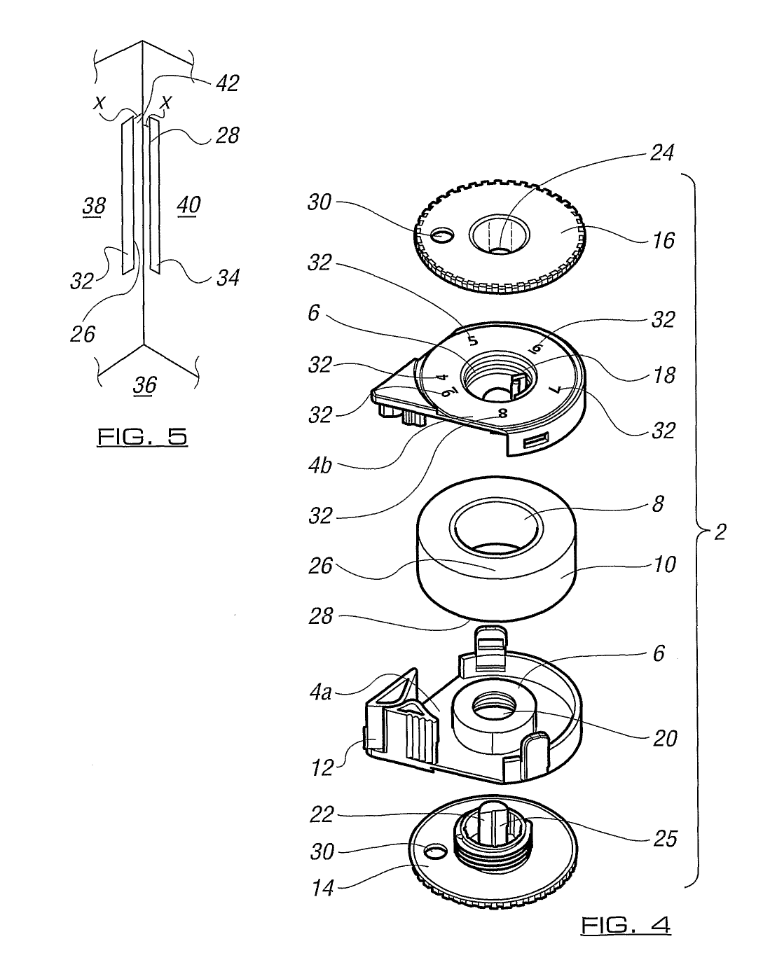

FIG. 5 illustrates an illustration of tapes applied in accordance with the invention;

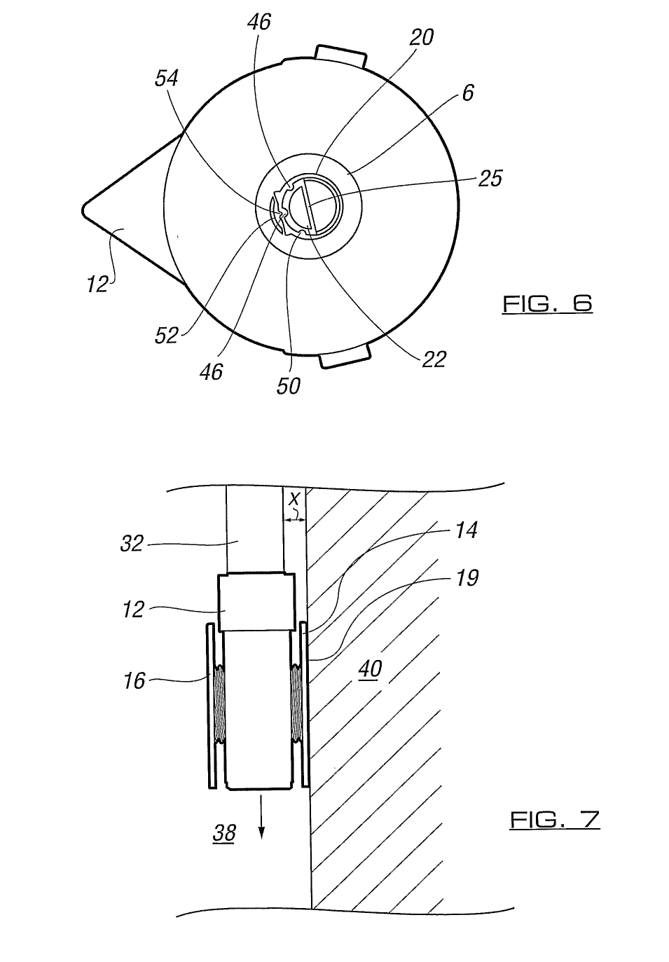

FIG. 6 illustrates a plain view of part of the body of the device; and

FIG. 7 illustrates the device in use to apply tape.

Referring firstly to FIG. 4 there is illustrated the components of a device 2 in accordance with the invention which comprises a body portion 4 formed of first and second parts 4a, 4b joined together. The body includes a spool 6 which receives the core 8 of a roll of adhesive tape 10 which is thereby supported within the body. The body includes a nib formation 12 to which the free end of the tape is supplied for application from the applicator device. The nib is typically shaped so as to allow the tape to be applied in relatively confined spaces.

The device also includes first and second side wall portions 14, 16 which are respectively positioned on opposing sides of the body. The portions 14 and 16 are located with the body via respective threaded protrusions 13, 15 which are received in respective threaded apertures 18, 20 in the body which typically can be formed with opposing threads.

Each of the side wall portions are provided with a member 22, 24 respectively. The members are of a length such that when the side wall portions are connected to the body 4, the flats 25 on the members engage such that a drive rotation exerted by a user on one of the side wall portions is transferred to drive and also rotate the other side wall portion. This transfer of the drive and the configuration of the respective threaded engagement means that each of the side wall portions can be moved inwardly or outwardly of the body by the same amount. This in turn means that the distance between the adjacent longitudinal edge 26 of the tape held within the body on the spool and the external surface of the side wall portion 16 is the same as the distance between the longitudinal edge 28 of the tape and the external surface of the side wall portion 14, at any given time and after adjustment in position of one of the side walls as the other side wall is adjusted at the same time. It should however be appreciated that the offset of one of the side wall portions can be different to that of the other sidewall portion if it suits a specific purpose.

At least one of the side wall portions is preferably provided with a viewing aperture 30 which allows one of a number of predetermined distance markings 32 on the body to be viewed so that the user is aware of the said offset side wall portion distance setting. It is also possible that a releasable locking or retention mechanism is provided such that when a predetermined distance marking is reached the device is retained in that position during use, such as, for example by a releasable detent system. The predetermined distance marking is selected as an indication of the distance from a known datum.

FIG. 1 illustrates views of the device 2 in an assembled position in which the respective external faces 19,21 of each of the side wall portions 14, 16 are at a first known distance “4” from the respective longitudinal edges of the tape held within the body. The predetermined distance is viewable through the aperture 30. In order to adjust the distance, at least one of the side wall portions is rotated by the user about axis 35 with respect to the body 4 of the device so as to move both of the sidewall portions with respect to the body, in this case outwardly as indicated by arrows 41, to the position shown in FIG. 2 in which the distance “5” is reached, and it will be seen that the offset distance X of the external surface 19,21 of the side wall portions from the longitudinal edges 26, 28 of the tape has increased in comparison to FIG. 1.

If a greater offset distance is required the said one or both side wall portions 14, 16 can be further rotated about axis 39 so as to increase the offset distance X to setting “9” in the example shown in FIG. 3.

It should be appreciated that in another embodiment of the device the side wall portions can be independently adjustable or only one of the portions may be adjustable, in terms of the offset distance. In this case the members 24, 25 on the side wall portions need not be provided to interengage

FIG. 5 illustrates two lengths of tape 32, 34 applied using the applicator device 2 of the invention at an interface 36 which, in this case, is a 90° corner between first and second walls 38, 40. The longitudinal edge 26 of the tape 32 adjacent the interface 36 and the longitudinal edge 28 of the tape 34 adjacent the interface are both offset a known distance X from the interface 36 as the tapes have been applied via the applicator device with the side wall portions 14, 16 having been adjusted as described above. Thus, in use, to apply the first tape to the wall 38 the external surface of the side wall portion 16 is contacted with the second wall 40 which acts as the datum line along which the applicator is moved as the tape is adhered to the will 38 for the required length. The second tape is applied to the wall 40 with the external face of the side wall portion 14 of the device contacting with the first wall 38 which acts as the datum line. The application of the tapes in this manner leaves a gap 42 at the interface to which, in this example, a sealing material can be applied along the uniform gap 42 formed, while ensuring that the wall surfaces adjacent the interface 36 are protected by the tape.

FIG. 7 illustrates the application device of the invention being used to apply a length of tape 32 along a surface 38. The tape is applied from the application nib 12 for the required length. At the same time as moving the device along the surface 38 to apply the tape, the external face 19 of the side wall portion 14 is contacted with the datum in the form of the right angled wall 40 which acts as the guide or datum to thereby ensure that the tape is applied along a constant offset distance from the datum and hence interface between the surfaces 38 and 40. It should also be noted that for other uses, the datum could be a line along which the side wall portion 14 external face 19 is moved.

Referring now to FIG. 6 there is illustrated one arrangement for a locking mechanism for the position of the side wall portions at one of the predetermined offset distance locations. In this case the member 22 of the side wall portion 14 is shown protruding through aperture 20 in the body. The member has a flat 25 and, at the curved surface 44 a series of spaced indents 46, 48, 50. The body includes a resilient part 52 which biases protrusion 54 into contact with the curved part of the member and, in particular, towards engagement with the indents as the side wall portion and hence member 22 is rotated. The location of each of the indents matches one of the displayed predetermined offset distances 30, and so when engaged with the protrusion, the side wall portions are retained in that position. Typically further indents will be provided on the curved surface of the other member 24 to be selectively engaged by the protrusion.

There is therefore provided in accordance with, the invention an offset tape applicator which is efficient in use, allows the accurate location of the tape with regard to a datum, and is adjustable with regard to the distance of offset of the applied tape from the datum.

1. A tape applicator device, said device including a supply of the tape to be dispensed, and at least one side wall portion which lies to a side of the longitudinal edges of the tape and wherein at least part of the external surface of said at least one side wall portion of the applicator device can be selectively positioned at a distance from the adjacent longitudinal edge of the tape.

2. A device according to claim 1 wherein said distance is adjustable by selectively moving the side wall portion with respect to the tape.

3. A device according to claim 1 wherein the distance is adjustable by selectively moving the side wall portion with respect to a body of the device on which the tape is mounted.

4. A device according to claim 1 wherein the selected distance is one of a range of predetermined distances.

5. A device according to claim 1 wherein the device includes a mechanism to allow the selected distance position to be retained by releasable locking means thereby maintaining the selected distance during use.

6. A device according to claim 1 wherein first and second side wall portions are located on opposing sides of the tape and are selectively movable so as to allow the distance between the external surface of the same and the respective adjacent longitudinal edge of the tape to be selected.

7. A device according to claim 6 wherein the first and second side wall portions are each moveable to the same offset position with respect to their respective longitudinal tape edges in an opposing direction.

8. A device according to claim 7 wherein the side wall portions are moveable together and apart in opposing directions.

9. A device according to claim 8 wherein the side wall portions are provided with inwardly extending members which contact within the device such that rotation of one member causes rotation of the other member and hence movement of the side wall portions in opposing directions.

10. A device according to claim 8 wherein each of the side wall portions are threaded with opposing threads and are received in a threaded part of the body of the device.

11. A device according to claim 10 wherein the body supports the tape supply.

12. A device according to claim 11 wherein the tape supply is provided as a roll, the core of which is received and retained on the body of the device.

13. A device according to claim 1 wherein the free end of the tape is passed to an applicator nib, such that the tape end can be applied to a surface and the movement of the applicator nib with a device along a surface causes the tape to be drawn from the roll and adhered along the surface.

14. A device according to claim 1 wherein the tape is a foil with an adhesive face which allows the tape to be applied in position onto a surface.

15. A tape applicator device with means to allow the user to select to apply a length of tape along a surface at a linear location which is offset a distance from a known datum.

16. A tape applicator device according to claim 15 wherein either or both of the longitudinal edges of the tape can be positioned at a user selected predetermined offset distance from a datum.

17. A tape applicator device according to any of the preceding claims wherein the device includes a first side wall portion to be placed with respect to a first datum to allow a first length of tape to be applied along a surface and a second side wall portion to be placed with respect to the first or a further datum to allow a second length of tape to be applied.

18. A tape applicator device according to claim 17 wherein the first and second length of tape are spaced apart along adjacent longitudinal edges

19. A method of applying a tape to a surface, said method comprising placing an adhesive tape supply in an applicator device, applying the free end of the tape onto the surface and adhering the tape to the surface by moving the device with respect to the surface to draw the tape from the device and wherein at least one of the longitudinal edges of the tape is located so as to be offset a known distance from a datum line or surface by selective adjustment of at least part of a side wall portion of the device and which side wall portion is positioned to contact with and/or be moved along the datum line or surface.

20. A method according to claim 19 wherein the said side wall portion is releasably locked in position at any of a predetermined range of distances from the longitudinal edge of the tape.

21. A method according to claim 19 wherein first and second opposed side wall portions are provided to be adjustable to allow the offset distance between each side wall portion external face and the adjacent longitudinal edge of the tape to be adjusted.

22. A method according to claim 19 wherein the applicator device is used to apply tape to either or both of two planer surfaces at a position offset from an angled interface between said surfaces so as to leave an exposed area along the interface.

23. A method according to claim 22 wherein a substance is applied along the said exposed area and thereafter the tape is removed to leave the substance in position with neatly finished edges.

24. A method according to claim 22 wherein when the first tape is applied to a first surface the second surface acts as the datum by being contacted by the external face of one of the side wall portions as the tape is applied, and the second tape is subsequently applied to the second surface with the first surface acting as the datum by being contacted by the external face of the same or the other of the side wall portions as the tape is applied.

25. A method according to claim 24 wherein each of the tapes is offset from the interface by a known distance, on either side of the interface.

26. A method according to claim 25 wherein the known distance is the same for both tapes.

27. A method according to claim 25 wherein the known offset distance is different for said tapes.
